(19) United States
(12) Patent Application Publication
(10) Pub. No.: US 2008/0258999 A1
(43) Pub. Date: Oct. 23, 2008

(54) Chameleon Glasses

(75) Inventor: Markus Gerardus Leonardus Maria Van Doorn, 's-Hertogenbosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/158,541

(22) PCT Filed: Dec. 14, 2006
(86) PCT No.: PCT/IB06/54849

§ 371 Date: Jun. 20, 2008

(30) Foreign Application Priority Data
Dec. 22, 2005 (EP) 05112808.0

(51) Int. Cl. G09G 3/19

(52) U.S. Cl. 345/49

(57) ABSTRACT

A color coordinating personal use device including a color detector (16) to detect a color of an object of personal use and a color changing material (18) of the personal use item that color changes to a color based on the detected color.

The present system relates to items of personal property that are worn or carried by a person, and, in particular, relates to the desire to coordinate colors of these items, and, in greater particularity, relates to color coordination of glasses with clothing worn by the person.

### DESCRIPTION OF THE RELATED ART

Color coordination is an important aspect of not only home decorations but also of personal appearance. Generally, people given a choice, will dress with appropriate color matching between objects of personal use such as shoes, dresses, shirts, coats, hats, hand bags, etc. For some personal use items this ability to select colors is limited. For example, cells phones have interchangeable cover plates and thus one would have to have the proper colored cover plate available to match another item of personal use. Further, an extra effort is required to change the color of a cell phone even if the right color is available. Matching items of personal use also requires that a person have multiple items of different colors available such as with sun glasses or other types of glasses. Some glasses change shades when exposed to different levels of sun light, but not colors.

The ability to change colors typically requires complex chemicals and/or complex electronic systems as illustrated in the below documents, all of which are incorporated by reference in entirety.

International Patent Publication No. WO 03/048852, discloses a color cell that may be applied to a car or textile as shown. The color cell has a layer of electrochromic material between two electrode layers which is controlled electronically to change color based upon an ambient color detected by an array of photodetectors. It is thus seen that this system will change colors to adjust to the color of the environment.

Another system for changing colors is disclosed by European patent application 93302067.9 dated Mar. 18, 1993. In this system, the color of the device such as a phone housing is covered. An electrically switchable light modulating material being an electrochromic material is positioned between two conducting layers which can connected to a variable voltage source. When an appropriate voltage is applied, the modulating material becomes transparent and the color underlying this layer becomes visible but the color is otherwise opaque and is the color of the pigments in the modulating material. A variety of colors may be shown by making combinations of red, green, and blue strips, in groups of three. The voltage source may be applied to each color strip separately in order to make the desired strip transparent. By applying the voltage in a selected manner, for example, the phone cover may flash red for an incoming call, etc. The use of this system is noted for a telephone cover and a wristband attached to the device.

Korean patent application 10109980037518 dated Sep. 11, 1998, discloses a “chameleon pager” wherein a thermo chromic material is heated by a resistor connected to a voltage source to indicate a battery level for example. This device is not responsive to any environmental colors.

U.S. Pat. No. 5,184,156 issued Feb. 2, 1994, to Black et al. discloses a pair of special glasses fitted with electronics to drive color-switchable lenses to prevent radiation of a specific wavelength from passing through the glasses. The glass plates are composed of conductive layers, color polarizers, alignment layers, a neutral polarizer and liquid-crystal layers. By the application of voltages to the color-switchable lenses, the spectral transmittance characteristics of the lenses can be changed based up the incoming radiation.

U.S. Pat. No. 6,608,996 issued Aug. 19, 2004, to Laurikka et al. discloses a means for changing the color of a device such as a cell phone based on information received. The patent uses electronic ink having micro capsules with colored particles therein. The colored particles are charged and thus by application of an external voltage, the particles may be selectively moved to the top of the capsule where the particles color is seen. The present system is directed at a means of displaying information about incoming calls, etc., to a user using the displayed color.

U.S. Pat. No. 6,888,322 issued May 3, 2005, to Dowling et al., discloses a device and method of changing the color of an enclosure of a device such as a computer housing based upon sensor, interface inputs, or other signals. One or more LEDs, being of different colors, are mounted in the device and are driven by the controller of the patent to produce the desired color changes.

United States Patent Application Publication US 2005/0040774 dated Feb. 24, 2005, discloses methods and apparatus for generating and modulating white light illumination condition using for example LEDs. This patent is directed at the environmental color present in an office, display room, etc. The color of the object is not changed.

European Patent Application EP 1462711 dated Aug. 23, 2003, discloses an LED lighting device being a color temperature regulable LED light source for use in operations, as a makeup light or for a living room light.

It is an object of the present system to overcome these and other disadvantages in the prior art.

There exists a need for a means of changing the color of an object based upon a desire of the user that is directed at a fashion statement. The present system provides a method and a system for color coordinating a personal use item with a color of another object of personal use.

The present system provides a means of changing a color of the personal use item to change its color to color coordinate with the object of personal use by selecting the object of personal use and positioning the personal use item in close proximity to the object of personal use. The present system further provides a system for color coordinating a personal use item with a color of another object of personal use by means for changing color wherein the user selects the color of the personal use item through an interface of the personal use item. The present system provides a color selecting device and method for color coordinating objects of personal use such as a shirt, a coat, a dress, a hat, paints, and shoes, with personal use items such as a cell phone, a personal digital assistance (PDA), a cell phone, laptop, glasses, etc. In one embodiment, the present system provides a color selecting device and method that uses color changing means including LEDs, a thermo chromic material, an electronic ink, and an electrochromic material.

The present system is directed at color coordinating an object of personal use with a personal use item by means of a color selecting device incorporated into the personal use item. For example, the object of personal use may be a “green” dress and the personal use item may be a pair of sun glasses. In accordance with an embodiment of the present system, the sun glasses have incorporated therein the color selecting device including a color-changeable material, a source of power, an electronic circuit, a color sensor, and a user interface. Through the user interface, the user is able to turn on the electronic circuit and select a color scheme for the sun glasses. The user may want to pick a color other than the green color of the dress to match to the dress, such as yellow. By appropriate inputs through the interface this color may be selected, but the user may rely on the color sensor to enable matching the color with the object of personal use. Therefore, the color selecting device may use the color sensor to match the color of the sun glasses to the green dress. In accordance with a further embodiment, after a predetermined interval of time, the color selecting device may partially turn off except for the function of maintaining the color of the personal use item. In another embodiment, certain environmental conditions may further trigger, after a predetermined time, the color selecting device to turn off. For example, placing the personal use item in a darkened enclosure such as a pocket, glove compartment, a drawer, etc., may turn the color selecting device off for the purpose of minimizing power drain.

The following are descriptions of illustrative embodiments that when taken in conjunction with the following drawings will demonstrate the above noted features and advantages, as well as further ones. In the following description, for purposes of explanation rather than limitation, specific details are set forth such as the particular architecture, interfaces, techniques, etc., for illustration. However, it will be apparent to those of ordinary skill in the art that other embodiments that depart from these specific details are within the scope of the appended claims. Moreover, for the purpose of clarity, detailed descriptions of well-known devices, circuits, and methods are omitted so as not to obscure the description of the present system.

It should be expressly understood that the drawings are included for illustrative purposes and do not represent the scope of the present system. In the accompanying drawings, like reference numbers in different drawings designate similar elements.

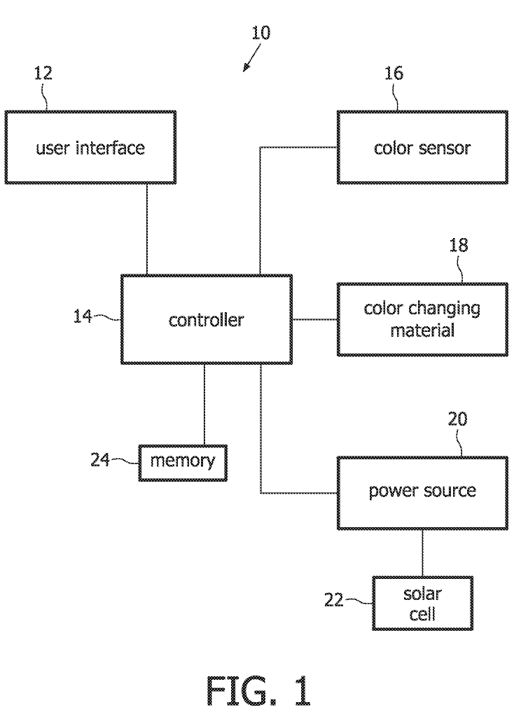

FIG. 1 is a functional block diagram of the color selecting device of the present system; and

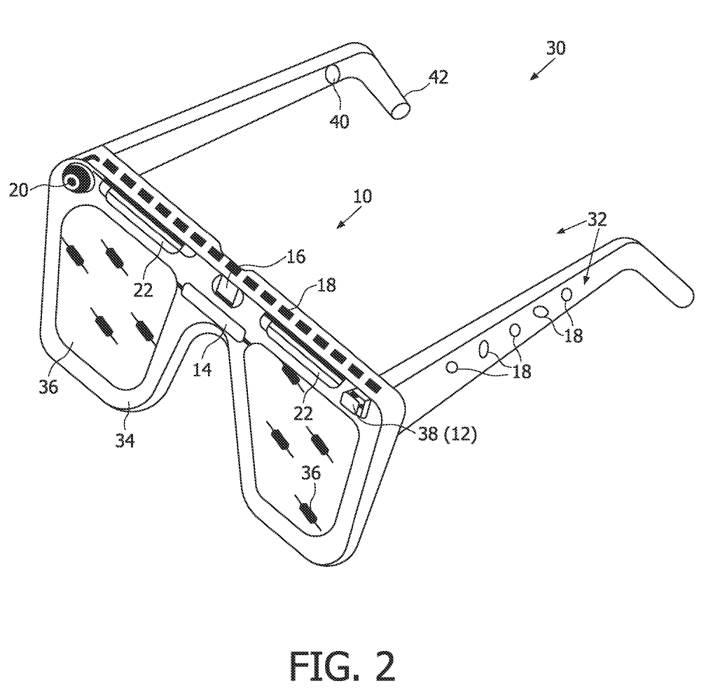

FIG. 2 illustrates a pair of sun glasses in accordance with an embodiment of the present system

The present system provides a system and method of color coordinating a personal use item with an object of person use.

Although specific examples of embodiments of such color coordination is shown and discussed, the present system clearly may be applied to other items and objects.

Referring to FIG. 1, an illustrative functional block diagram of the present system is shown by way of example.

A color selecting device 10 includes several components such as a user interface 12, controller 14, such as a microcontroller, microprocessor, and the like, for controlling the color selecting device 10, a color sensor 16 being for example, sensitive to red, green and blue (RGB), a color changing material 18, and a power source 20 which may include a solar cell 22. As shown, the controller 14 is operably coupled to the user interface 12 for facilitating user interaction with the color selecting device 10. The controller is also operably coupled to the color sensor 16, the color changing material 18, and the power source 20 for operation in accordance with the present system.

The user interface 12 may include several different devices so that a user may input information into the color selecting device 10. In various embodiments, the user interface 12 may include a heat sensor, a motion sensor, a light sensor, for example.

FIG. 2 illustrates an embodiment of the present system wherein the personal use item is a pair of sunglasses 30 which has the color selecting device 10 incorporated therein by appropriate molding techniques. The sunglasses 30 are composed of a housing of essential translucent or clear material, such as plastic. The housing includes a pair of arms 32, a front frame 34 coupled (e.g., hinged) to the arms 32 in a conventional manner, and a pair of lens 36. The color changing material 18 is operationally positioned along a front top portion of the front frame 34 and along the arm 32 for the purposes of the following discussion so as not to obscure other elements of the glasses 30. In actual construction, the color changing material may be positioned in numerous areas and in numerous ways without deviating from the present system. For example, the color changing material may be embedded in the frame and arms 32, along selected portions, in a form of a string of RGB triplets of LEDs.

Illustratively, the user interface 12 may be a light sensor 38. In an embodiment, to turn on the color selecting device 10, the user may place a finger over the light sensor 38 for a predetermined period of time such as 3 seconds. In the normal off mode, i.e., conserving energy, the color selecting device 10 may maintain certain items in an on-state and the user interface 12 may be one of them. When the user instructs the color selecting device 10 through the user interface 38 to turn on, certain actions may be taken as will be described.

In another embodiment, the user interface 12 may also be a heat sensor 40 which is located on one of the arms 32 and is on an inside portion of the arm so that it is in close proximity to the skin of the user when the user is wearing the glasses and thus, the heat sensor 40 is positioned to sense heat given off by the user. In this embodiment, the heat sensed from the user by the heat sensor 40 may indicate that the user is wearing the sunglasses 30 and may operate to keep the color selecting device 10 in an “on” state as determined by the controller 14. The controller 14 may utilize multiple sources of information to determine a suitable state or visual display characteristic, such as intensity, color, hue, saturation, and of the like, for the color selecting device 10. For example, in a case wherein a user wearing the glasses 30 enters a dark room, the light sensor 38 after a predetermined time might send a signal to the controller 14 indicating to shut the color selecting device 10 off, however the heat sensor 40 may send a signal to the controller 14 indicating that the user still has the sunglasses 30 on. Accordingly, the controller 14 may only power down the color selecting device 10 to an intermediate mode to conserve energy. For example, the color changing material 18 may be placed in an off mode to conserve energy in a dark environment or conversely, the color changing material 18 may be placed in a high intensity mode have another color characteristic altered to facilitate user navigation in the dark environment. In another embodiment, the user interface 12 may be a motion sensor to indicate that the sunglasses 30 are being carried, for example to help identify when to enter an off or low power state. In yet another embodiment, the user interface 12 may be a physical switch (e.g., small) positioned on the glasses. The switch provides another way for the user to turn the color selecting device on/off.

The power source 20 may be a small high power, button-type battery 20. In a further embodiment, an additional and/or alternate power source may be the solar cells 22, which illustratively may be positioned along a top of the front frame 34 as shown in FIG. 2. In one embodiment wherein both the battery 20 and the solar cells 22 are present, the solar cells 22 may recharge the battery 20 whenever sufficient light exists to make this possible. Further, in place or together with the solar cells, there may be positioned a kinetic generator that produces energy in response to motion of the user. A further additional source of power may be an external battery (not shown) that may be connected to the sunglasses 30 via an input terminal 42, for example.

Although the color sensor 16 is shown positioned on a front of the frame 346, clearly the color sensor 16 may be positioned in other suitable locations, such as on either of arms 32.

In order for the color of the sunglasses 30 to color match an object of personal use, such as a colored dress, the color sensor 16 may be placed in close proximity to the colored dress for a given time to allow the color information of the dress to be input into the color selecting device 10. A duration required for capturing color information may be programmable through operation of the user interface 38. For example, the duration may be set to a short interval to enable frequent changes of the color matching/complementing/etc. The duration may also be set for a longer interval to ensure that color changing does not occur inadvertently. In other embodiments, the color sensor 16 may be placed in a mode through operation of the user interface 38 to capture color information. In one embodiment, the color sensor 16 may include RGB sensors therein, to match the color of the color changing material 18 to the object of personal use. In the same or a further embodiment, a user may desire other colors be exhibited by the color changing material 18 that complement a color of the object of personal use. For example, a pair of yellow sunglasses 30 may complement a green dress. Red sunglasses may complement a black dress and so on.

In one embodiment, a memory 24 is operably coupled to the controller 14 and is operable to store instructions and data, such as operating instructions, to be executed by the controller 14 for operation as described. The memory 24 may also be operable to store color relationship information, such as color wheel relationships. In this way, the color selecting device 10 may provide a method of addressing this problem by enabling the user to interface with the color selecting device 10 to select one or more alternate colors that are related (e.g., analogous, complementary, etc.) to the detected color of the object of personal use. For example, the user may interact with the user interface 38 by covering and uncovering the light sensor 38, one or more times within a period of time, to indicate a desired related color. Based on this information, the color changing material 18, embedded in the frame of the glasses 30 may change colors to the desired related color.

In a further embodiment, the controller 14 may recall a last selected color and return to this color when the user turns the power on, for example or when the color selecting device 10 goes from the off-mode or from the intermediate-mode to the on-mode. The user interface 12 may also be utilized to select and set presets.

The type of color changing material 18 may include electrochromic material, thermo chromic material, electronic ink or LED type sources. In one embodiment, the color changing material may be one or more RGB triplets of LED lights to facilitate a multiplicity of color options. The RGB triplets may be embedded in one or more portions of a translucent frame of the glasses 30 to facilitate color changing of the glasses. In an embodiment wherein a thermo chromic material is used in the sunglasses 30, appropriate resistors may be incorporated therein. A resistive material may be included in clear plastic frames of the glasses so that current sources may be placed at several distal positions such as at the end of the arms 32 and at the lower corners of the front frame 34. In this way, the current flows to a sink at the top front and in the process cause the thermo chromic material to change color.

In another embodiment, the color changing material may be the electrochromic material. A thin layer of this non-conducting material may be incorporated between two conducting electrodes. By an appropriate voltage placed thereon by the controller 14, the electrochromic material may change colors as desired. During the intermediate-mode or the off-mode, the charge may readily be maintained on the electrodes by an open circuit condition.

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts or steps is intended to be required unless specifically indicated.

1. A method of color coordinating a personal use item, comprising the acts of:
detecting a color of an object of personal use; and
activating a color changing material of the personal use item to change to a color based on the detected color.

2. The method of claim 1, comprising the act of changing a visual display characteristic of the color changing material after a change in an environment of the personal use item.

3. The method of claim 2, wherein the change in the environment is a transition from a light environment to a dark environment.

4. The method of claim 2, wherein changing the visual display characteristic of the color changing material comprises the act of changing intensity.

5. The method of claim 2, wherein the change in the environment is a transition from a warm environment to a comparatively cooler environment.

6. The method of claim 1, wherein detecting the color of the object of personal use comprises the acts of:
placing the personal use item in close proximity to the object of personal use; and
sensing with a color sensor the color of the object of personal use.

7. The method of claim 1, wherein the act of activating comprises the act of providing a user a color selection for the color of the color changing material.

8. The method of claim 1, wherein the act of activating comprises the act activating a plurality of RGB triplets of LEDs operably disposed to the personal use item.

9. A color coordinating personal use device comprising:
a color detector (16) configured to detect a color of an object of personal use; and
a color changing material (18) of the personal use item configured to change to a color based on the detected color.

10. The device of claim 9, comprising a detector (12, 40) configured to detect a change in an environment of the personal use item, wherein the color changing material (18) is configured to change a visual display characteristic responsive to the detected change in the environment.

11. The device of claim 9, wherein changing the visual display characteristic of the color changing material (18) comprises changing intensity.

12. The device of claim 10, wherein the detector (12, 40) is configured to detect a transition from a warm environment to a comparatively cooler environment.

13. The device of claim 9, comprising a user interface (12, 40) configured to provide a user a color selection for the color of the color changing material (18).

14. The device of claim 9, wherein the color changing material (18) comprises a plurality of RGB triplets of LEDs (18) operably disposed to the personal use item.

15. The device of claim 9, wherein the device comprises a pair of glasses (30).

16. The device of claim 9, wherein the device comprises one of a PDA, a cell-phone, and a laptop.

17. The device of claim 9, comprising a controller (14), operably coupled to the color detector (16) and the color changing material (18), wherein the controller (14) is configured at start up to recall a last selected color and is configured to control the color changing material to change to the last selected color.
